(19) United States
(12) Patent Application Publication
(10) Pub. No.: US 2018/0174251 A1
(43) Pub. Date: Jun. 21, 2018

(54) METHOD FOR AUTOMATING NEGOTIATION OF GOODS

(71) Applicant: Infoxchg Corp, Sunnyvale, CA (US)

(72) Inventors: Satish Padmanabhan, Sunnyvale, CA (US); Fuk Ho Pius Ng, Camas, WA (US); Lisa Higa, San Francisco, CA (US); Christine Renschler, San Francisco, CA (US); Yashwant Sakarchand Kothari, Fremont, CA (US); Abinaya Senthil, Cupertino, CA (US); Shalini Satish, Sunnyvale, CA (US)

(21) Appl. No.: 15/382,344

(22) Filed: Dec. 16, 2016

(51) Int. Cl. G06Q 50/12; G06Q 50/18; G06Q 10/02; G06Q 30/06; G06Q 30/02

(52) U.S. Cl. CPC G06Q 50/12; G06Q 50/188; G06Q 30/0222; G06Q 30/0635; G06Q 10/02

(57) ABSTRACT

One variation of a method for automating negotiation of goods includes: initiating a transaction negotiation package specifying a restaurant, a reservation date and time, a selection of items, and an initial monetary offer for the set of items selected by a user; retrieving a target discount rate associated with the restaurant and an aggregate discount rate negotiated across transactions previously completed with the restaurant; selecting a maximum discount rate for the transaction negotiation package based on a difference between the preset target discount rate and the aggregate discount rate; if the initial monetary offer represents an initial discount rate greater than the maximum discount rate, serving a first monetary counter offer—representing a first counter discount rate less than the maximum discount rate—to the user; and processing payment for the selection of items according to the first monetary counter offer if the first monetary counter offer is accepted.

### TECHNICAL FIELD

This invention relates generally to the field of transaction processing and more specifically to a new and useful method for automating negotiation of goods in the field of transaction processing.

### BRIEF DESCRIPTION OF THE FIGURES

FIG. 1 is a flowchart representation of a method;

FIG. 2 is a flowchart representation of one variation of the method;

FIG. 3 is a graphical representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

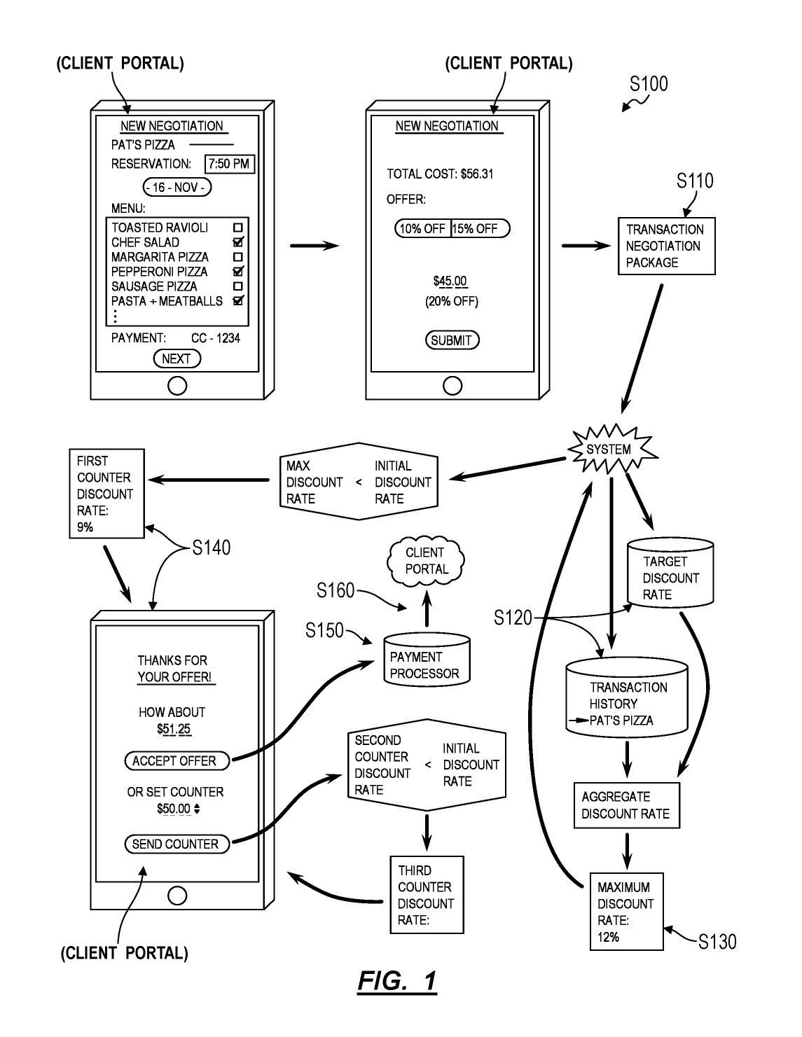

As shown in FIG. 1, a method for automating negotiation of goods includes: initiating a transaction negotiation package based on a restaurant, a reservation date, a reservation time, a selection of menu items, and an initial monetary offer for the selection of menu items selected by a user through a customer portal executing on a computing device in Block S110; retrieving, from a database, a target discount rate associated with the restaurant and an aggregate discount rate of final discount rates negotiated for a set of transactions completed with the restaurant over a preceding period of time in Block S120; selecting a maximum discount rate for the transaction negotiation package based on a function of (e.g., a difference between) the preset target discount rate and the aggregate discount rate in Block S130; in response to the initial monetary offer representing an initial discount rate greater than the maximum discount rate, serving a first monetary counter offer through the customer portal in Block S140, wherein the first monetary counter offer represents a first counter discount rate less than the maximum discount rate; in response to acceptance of the first monetary counter offer by the user through the customer portal, processing payment for the selection of menu items according to the first monetary counter offer in Block S150; and transmitting the reservation date, the reservation time, and the selection of menu items to the restaurant in Block S160.

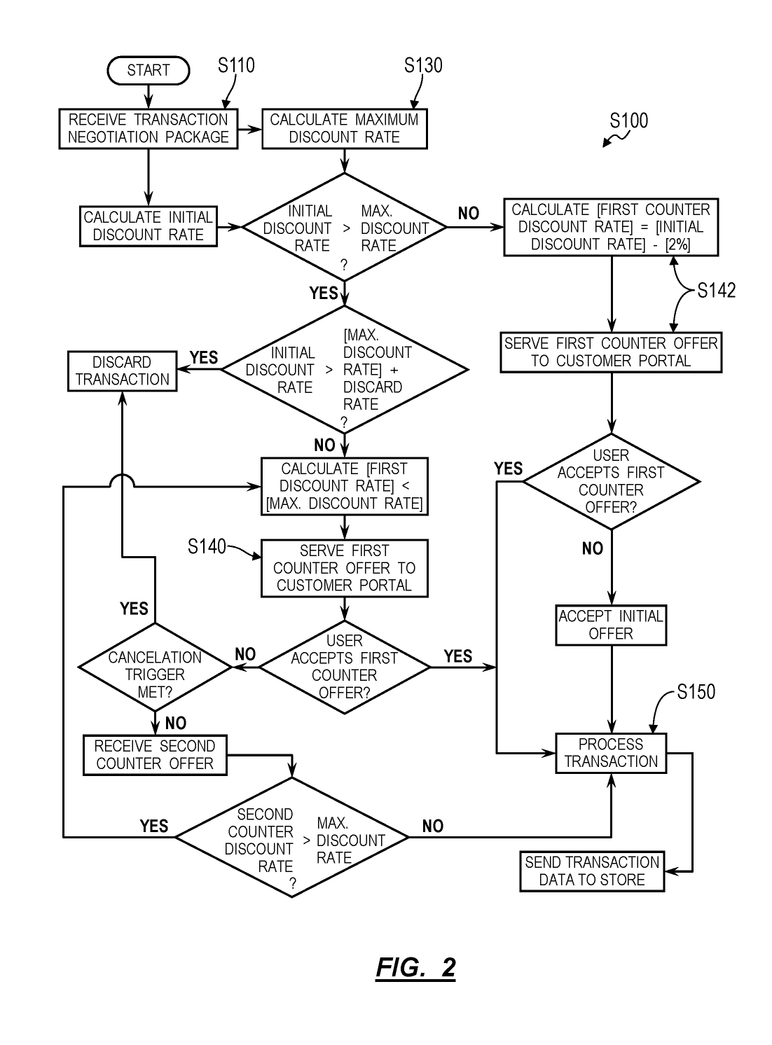

As shown in FIG. 2, one variation of the method for automating negotiation of goods includes: initiating a transaction negotiation package based on a vendor, a purchase value, and an initial monetary offer for the purchase value selected by a user through a customer portal executing on a computing device in Block S110; retrieving, from a database, a target discount rate associated with the restaurant and an aggregate discount rate of final discount rates negotiated for a set of transactions completed with the restaurant over a preceding period of time in Block S120; selecting a maximum discount rate for the transaction negotiation package based on a function of the preset target discount rate and the aggregate discount rate in Block S130; in response to the initial monetary offer representing an initial discount rate less than the maximum discount rate calculating a first counter discount rate as a linear combination of the maximum discount rate and the initial discount rate and serving a first monetary counter offer through the customer portal in Block S142, wherein the first monetary counter offer represents the first counter discount rate; in response to the initial monetary offer representing the initial discount rate greater than the maximum discount rate, serving a second monetary counter offer through the customer portal in Block S140, wherein the second monetary counter offer represents a second counter discount rate less than the maximum discount rate; in response to acceptance of one of the first monetary counter offer and the second monetary counter offer by the user through the customer portal, processing payment for the selection of menu items according to the second monetary counter offer in Block S150; and transmitting confirmation of the transaction, the purchase value, and payment for the purchase value to the vendor in Block S160.

### 2. Applications

Generally, Blocks of the method can be executed locally on a user's computing device and/or remotely by a remote computer system to: receive, from a user, a selection of goods offered by a business entity and a monetary offer for these goods, which may be less than a total list or retail price for these goods; customize a maximum discount rate allowed for this transaction with the user based on actual discount rates provided in previous transaction with the business entity and a preset target discount rate for the business entity; and to automatically negotiate with the user through her computing device to either reject the user's offer or revise the user's offer to represent a discount rate that does not exceed the maximum discount rate set for this transaction with the user.

A native negotiation application executing on the user's computing device (e.g., a smartphone), a negotiation application accessed through a web browser executing on the user's computing device, and/or a remote computer system (e.g., a remote server)—hereinafter the “system”—can execute Blocks of the method. The system can execute Blocks of the method to set a custom maximum discount rate—for a new transaction with the user—that differs from a last discount rate provided to the user during a last transaction between the user and the business entity in order to obscure the target discount rate—preset by the business entity—from the user, thereby limiting the user's ability to request and receive the same discount rate from the business entity for all subsequent transactions, which would effect a substantially permanent discount rate from the business entity without substantially impacting revenue or margin for the business entity. In particular, by customizing a maximum discount value for a new transaction with a user—which may vary significantly from a discount rate negotiated for a previous transaction between the user and the business entity—and then automatically negotiating with the user through the user's computing device to reduce a discount rate offered by the user to below this maximum discount rate set for the user, the system can prevent the user from learning and then gaming discount parameters set by the business entity, thereby controlling user expectations, retaining discount controls set by business entities, and maintaining greater user engagement in the negotiations with the system.

The system can set a maximum discount rate for a new transaction with a user in order to maintain a total average discount rate—across many transactions made with the business entity through the system—that approximates the target discount rate set by the business entity. For example, though a business entity may set a 15% target discount rate for all transactions made with the business entity through the system, the system may set maximum discount rates between 2% and 25% for one user over a series of transactions between the user and the business entity made through the system and implement closed-loop feedback techniques to select a discount rate within this range for a next transaction between the user and the business entity based on a difference between the 15% target discount rate set for the business entity and a total discount rate provided to other users during recent transactions with the business entity. The system can also set the maximum discount rate for a new transaction initiated by a user based on: a time until the user's elected collection time for the selected goods; the user's transaction and negotiation history within the system and/or with the selected business entity; and/or a total list or retail price of the goods selected; etc., thereby both further customizing the maximum discount rate for the new transaction with the user and further obscuring target discount rates preset for the business entity.

Furthermore, by prompting the user to select both a set of goods (e.g., a set of menu items) offered by the business entity (e.g., a restaurant) and a collection time for this set of goods (e.g., a reservation date and reservation time) and then providing these data to the business entity upon successful completion of the negotiation, the system can enable the business entity to prepare ahead of time to provide the selected set of goods for the user and to focus its efforts on stocking or preparing goods that its customers demand at the most relevant dates and times. For example, for a new transaction with a restaurant, the system can: prompt the user to elect a reservation date and time; prompt the user to select a set of menu items from a digital menu provided by the restaurant; and then return this set of menu items to the restaurant prior to the elected reservation date and time. The restaurant can then implement these data to: adjust a meat and produce order ahead of the user's reservation to ensure sufficient product is on hand; and to prepare the user's meal at an early time relative to the user's arrival at the restaurant, thereby increasing throughput through the restaurant and increasing the restaurant's total revenues. In particular, by collecting data related to when the user intends to arrive at a restaurant, what items specifically the user intends to order from the restaurant during this reservation, and advance payment for these goods, the system can enable the restaurant to begin preparation of the user's selected menu items before the user arrives for her reservation, thereby: reducing total customer wait time at the restaurant; improving the user's experience (e.g., especially for hungry customers); increasing throughput at the restaurant; enabling the restaurant to predict and guarantee future sales; and enabling the restaurant to predict types and quantities of dishes sold during a period of time (e.g., one day or one meal block), thereby reducing food waste at the restaurant.

The method is described below as executed by a system (e.g., a native negotiation application executing on the user's smartphone and/or a remote computer system): to receive a selection of menu items and a reservation time and date for a restaurant from a user; to receive a monetary offer for the menu items from the user; to set a maximum discount rate for this new transaction with the user; to automatically negotiate with the user on behalf of the restaurant; to process payment for the transaction if certain discount rate criteria are met; and to then provide menu item selection, reservation date, and payment information for a successful negotiation to the restaurant. However, the system can implement similar methods and techniques for transactions between users and other business entities, such as clothing retailers, golf courses, grocery stores, electronics suppliers, etc.

Furthermore, the method is described below as executed by a system to negotiate discount rates for menu items provided by a restaurant. However, the system can similarly execute Blocks of the method to negotiate relative or absolute monetary discount amounts for single products, baskets of products, or a product value provided by any other business entity.

### 3. Initiating Transaction Negotiation Package

Block S110 of the method recites initiating a transaction negotiation package based on a restaurant, a reservation date, a reservation time, a selection of menu items by a user, and an initial monetary offer for the selection of menu items through a customer portal executing on a computing device. Generally, in Block S110, the system collects various data related to a new transaction between a user and a restaurant and prepares for a new negotiation with the user according to these data, as shown in FIGS. 1 and 2.

In one implementation, the system interfaces with the user through a customer portal hosted by native negotiation applications executing on the user's mobile computing device (e.g., a smartphone, a smartwatch) to collect data for the new transaction negotiation package in Block S110. (Alternatively, the system can interface with the user through a customer portal accessed through a web browser executing on a computing device.) Once opened by the user, the customer portal can prompt the user to select a restaurant, such as from a map or list of restaurants near the computing device's current geospatial location or from a map or list of restaurants meeting various search criteria (e.g., style, price, reviews, distance) entered by the user. The system can similarly prompt the user to select a reservation date and time to collect the selected menu items from the restaurant, such as in the form of a date and time for an eat-in meal at the restaurant, in the form of a date and time of pickup from the restaurant, or in the form of a date and time of delivery by the restaurant. For example, the system can prompt the user to select: one of an eat-in, pickup, or delivery field; an eat-in, pickup, or delivery date (i.e., a reservation date) from a digital calendar; and an eat-in, pickup, or delivery time (i.e., a reservation time) from a scroll-down menu. In this implementation, the system can also interface with an internal or external reservation system for the restaurant to selectively disable reservation dates and times fully or partially (e.g., more than 80%) booked at the time the user initiates this new transaction through the customer portal. The system can also prompt the user to enter—through the customer portal—a total number of patrons in the user's party.

The system can then: retrieve a digital list of menu items offered by the restaurant from a remote database; serve this digital list of menu items through the customer portal; and then prompt the user to select menu items from the digital list (e.g., by checking a box or entering a number of units in a text field adjacent each menu item). Upon receipt of this selection of menu items from the digital list and entered by the user through the customer portal, the system can: sum a total cost of the selection of menu items based on individual prices assigned to menu items in the digital list; present this total cost to the user through the customer portal; and prompt the user to enter an initial monetary offer proposing a reduced cost of the selection of menu items through the customer portal. For example, the system can prompt the user—through the customer portal—to select one of a preset list of discount rates (e.g., 10%, 20%, or 30%), to adjust a slider along a spectrum of discount rates (e.g., from 0% to 30%), or to select an integer discount rate from a dropdown menu (e.g., from 0% to 30% in 5% increments); the system (e.g., the remote server remotely or the customer portal locally) can then apply this discount to the total cost of the selected menu items to calculate the initial monetary offer (i.e., a “discounted total cost”) for the selection of menu items and then present this initial monetary offer through the customer portal, such as by inserting the initial monetary offer adjacent the original total cost for the selected menu items.

Alternatively, the system can prompt the user—through the customer portal—to enter an initial monetary offer (e.g., “$62.00”) directly into a text field within the customer portal. In particular, the system can prompt the user to enter a dollar amount she is willing to pay for the menu items selected, despite the list or retail prices of these menu items.

Yet alternatively, the system (e.g., the remote server remotely or the customer portal locally) can suggest an initial monetary offer (or discount rate) for the new transaction—such as based on the selected reservation date and time, the total cost of the selected menu items, and/or final transaction costs negotiated in recent successful transactions with other users—and prompt the user to select this initial monetary offer to complete the transaction negotiation package. The system can therefore suggest both an initial monetary offer for the user's new transaction in Block S110 and automatically negotiate with the user in Block S140 to shift this initial monetary offer to a final monetary offer that both fulfills a customer maximum discount rate selected for the user and discount parameters set for the restaurant.

Finally, the system can collect payment information from the user, such as by populating text fields with credit card information within the customer portal or by linking the user's account within the customer portal to an online payment system. Once the foregoing data are entered into the customer portal, the user can select a “submit” input region within the customer portal. The native negotiation application can then assemble these data into a new transaction negotiation package and return this transaction negotiation package to the remote computer system for processing, as described below.

In one implementation, a restaurant can also set a maximum number of negotiated transactions per unit time (e.g., per hour, per day, or per week) or for specific periods of time (e.g., Fridays between 5PM and 11PM), such as through the client portal described below. In this implementation, the system can maintain a count of transaction negotiation packages specifying the restaurant and submitted or confirmed over time; and can then immediately reject a new transaction negotiation package entered by the user if the current count of transaction negotiation packages specifying the restaurant has already reached the maximum number of transaction negotiation packages set by the restaurant

### 4. Target Discount Rate

Block S120 of the method recites retrieving, from a database: a target discount rate associated with the restaurant; and an aggregate discount rate of final discount rates negotiated for a set of transactions completed with the restaurant over a preceding period of time. Generally, in Block S120, the system prepares to select or calculate a custom maximum discount rate for the new transaction negotiation package by collecting relevant data, including a target average negotiated discount rate over a series of transactions with the restaurant negotiated over a period of time, such as for the current week, month, quarter, year, or all-time (hereinafter a “target discount rate”); and an actual average discount rate provided to customers of the restaurant over the same period of time.

In one implementation, the system hosts a client portal accessible by a representative of the restaurant, such as through a native client application or through a web browser executing on a desktop computer or tablet. In this implementation, the system can enable the representative of the restaurant to set and adjust the target discount rate for the restaurant through the client portal. For example, the representative of the restaurant can set—within the client portal—a target discount of 15% with an upper discount bound of 30% on the discount rate over a period of six months. The system can store these time and discount parameters into a remote database. The system can: later retrieve these parameters in Block S120; and then implement these parameters to set maximum discount rates for customers—initiating transactions with the restaurant—between a low bound (e.g., 0% or 5%) and the upper discount bound of 30% with an average of 15% for all customers over the same six-month period according to other Blocks of the method.

The system can also enable the representative of the restaurant to set multiple unique target discount rates and to link each target discount rate to a unique set of parameters through the client portal. For example, the representative of the restaurant can specify: a first target discount of 10% for transactions under $10 in total (pre-tax) value; a second target discount of 12% for transactions between $10 and $25 in total value; a third target discount of 15% for transactions between $25 and $50 in total value; and a fourth target discount of 17% for transactions over $50 in total value. As described above, the system can store these target discount rates. Upon receipt of a new transaction negotiation package, the system can retrieve the relevant target discount rate in Block S120 based on parameters defined in the transaction negotiation package.

Furthermore, following each successful negotiation with the restaurant, the system can store parameters of these negotiations—such as including reservations dates and times, total transaction cost, final negotiated monetary offers, and/or final negotiated discount rates, etc.—in a remote database. The system can also calculate metrics for negotiations completed automatically by the system on behalf of the restaurant, including an aggregate discount rate of final discount rates negotiated for a set of transactions completed with the restaurant over a preceding period of time such as in the form of: an average total discount rate applied across all previous transactions negotiated on behalf of the restaurant; an average total discount rate applied across previous transactions negotiated on behalf of the restaurant within the preset period of time; or a linear combination of total discount rate weighted by total cost of selected menu items (or “total transaction cost”). Once a new transaction negotiation package is initiated in Block S110, the system can retrieve this metric from the remote database in Block S120.

### 5. Maximum Discount Rate

Block S130 of the method recites selecting a maximum discount rate for the transaction negotiation package based on a difference between the preset target discount rate and the aggregate discount rate. Generally, in Block S130, the system sets a maximum discount rate allowable for the current transaction with the user in order to achieve or maintain the preset target discount rate for the restaurant while also obscuring the discount selection and negotiation mechanisms implemented by the system from the user.

### 5.1 Upper and Lower Discount Bounds

In one implementation, the system adjusts upper and lower discount bounds on possible discount rates for the new transaction negotiation package and then pseudorandomly selects a maximum discount rate for the transaction negotiation package from within these upper and lower discount bounds. For example, in Block S130, the system can: set a center discount rate below the target discount rate in response to the current aggregate discount rate exceeding the target discount rate; set the center discount rate for the transaction negotiation package above the target discount rate in response to the target discount rate exceeding the aggregate discount rate; calculate an upper discount bound offset from the center discount rate by a static discount rate (e.g., 8%) for the transaction negotiation package; calculate a lower discount bound offset from the center discount rate by the static discount rate for the transaction negotiation package; and then pseudorandomly select a maximum discount rate between the upper discount bound and the lower discount bound. In this example, the system can therefore implement closed-loop feedback techniques to shift the center discount rate based on a difference between the aggregate discount rate set for the restaurant and the target discount rate for the restaurant and then select a maximum discount value for the current transaction negotiation package that falls within these upper and lower discount bounds.

### 5.2 Closed-Loop Maximum Discount Rate Selection

In one implementation, the system can set a center discount rate (or the maximum discount rate directly) for the new transaction negotiation package based on an aggregate (e.g., running average) discount rate applied to successful transactions with the restaurant over a preceding period of time. In particular, the system can implement closed-loop methods to return a drifting aggregate discount rate back toward the target discount rate.

In this implementation, if the actual aggregate discount rate applied to successful transaction negotiation packages over a past week (or month, quarter, etc.) exceeds the target discount rate assigned to this same period of time; the system can select a center discount rate (or a maximum discount rate directly) that is less than the actual running average discount rate for a current transaction. For example, if the actual aggregate discount rate for the restaurant over the past week is 16% and the target discount rate set by the restaurant for the same period of time is 12%, the system can: shift the center discount rate to 10%; shift the upper discount bound for the current transaction to 15%; shift the lower discount bound for the current transaction to 5%; and select a maximum discount rate between the upper discount bound of 15% and the lower bound of 5% for the current transaction negotiation package. Therefore, regardless of the outcome of the new transaction negotiation package, the aggregate discount rate for the restaurant will either remain unchanged or decrease toward the target discount rate set for the restaurant.

Similarly, if the actual aggregate discount rate for transaction negotiation packages received over the past week is less than the target discount rate for the same period of time, the system can: select a center discount rate greater than the actual aggregate discount rate for a current transaction. For example, if the actual aggregate discount rate of successful transaction negotiation packages specifying the restaurant over the past 24 hours is 16% and the target discount rate for the same period of time is 20%, shift the lower discount bound of the discount rate for the current transaction to 16% (e.g., up from 8%), and select a maximum discount rate between the new lower discount bound of 16% and the original upper discount bound of 30% for the current transaction. Thus, regardless of the outcome of the transaction negotiation package, the aggregate discount rate for the restaurant will either remain unchanged or increase toward the target discount rate set for the restaurant.

However, the system can implement any other closed-loop methods or techniques to adjust the center discount rate and/or an offset between the upper and lower discount bounds. The system can implement similar methods and techniques to set the maximum discount rate for the new transaction negotiation package directly based on a difference between the aggregate discount rate applied to recent successful transaction negotiation packages and the target discount rate set for the restaurant.

### 5.3 Time-Based Discount Curves

In another implementation, the system can apply greater center discount rates (and therefore greater upper and lower discount rates) to transaction negotiation packages that specify reservation dates and times further into the future. In particular, the system can set center discount rates directly proportional (e.g., linearly, logarithmically, or exponentially proportional) to a duration of time between when the transaction negotiation package is entered by the user and the reservation date and time specified in the transaction negotiation package, thereby increasing—on average—the maximum discount rate selected for a transaction negotiation package specifying a reservation date further in the future and reducing—on average—the maximum discount rate selected for a transaction negotiation package specifying a reservation date in the very near future.

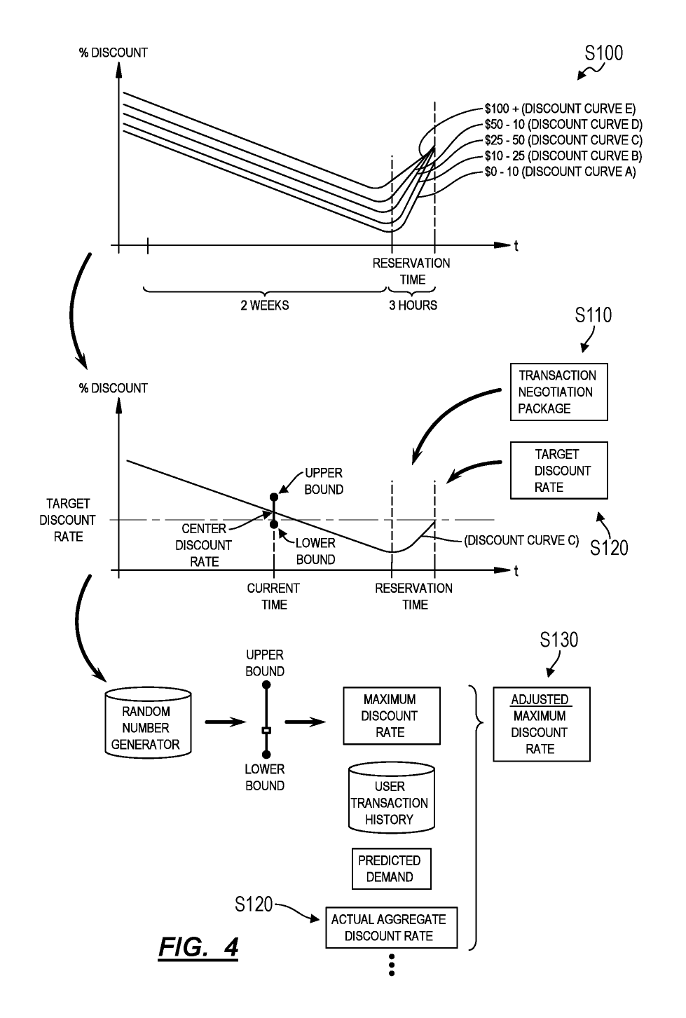

In this implementation, the system: retrieves a time-based discount curve defining a relationship between maximum discount rates and durations of time from a current time to proposed reservation dates and proposed reservation times; and then sets—according to the time-based discount curve—a center discount rate as an inverse function of a duration of time from the current time to the proposed reservation date and proposed reservation time specified in the transaction negotiation package, as shown in FIG. 4.

In this implementation, while the system can increase the center discount rate globally as a direct function of remaining time until the selected reservation date and time, the system can also increase the center discount rate locally just before (e.g., minutes or hours before) the selected reservation date and time is reached. For example, the system can access a time-based discount curve that defines an inflection preceding a reservation time by minutes or hours. Therefore, in this example, the system can set the center discount rate as an inverse function of the duration of time up to a time threshold before the reservation date and the reservation time specified in the transaction negotiation package and as a direct function of the duration of time from the time threshold to the reservation date and reservation time specified in the transaction negotiation package, as shown in FIG. 4. The system can thus implement a static, predefined time-based discount curve to increase—on average—a maximum discount rate selected for the new transaction negotiation package just before the selected reservation date and time in order to achieve greater patron density (i.e., to “pack” the restaurant) at the current time or at a time in the very near future. Alternatively, the system can dynamically adjust the tail of the time-based discount curve based on the (near) real-time capacity of the restaurant and then increase the center discount rate (or the maximum discount rate directly) for the current transaction negotiation package proportional to a number of currently empty seats in the restaurant.

The system can then implement methods and techniques described above to define upper and lower discount bounds for the new transaction negotiation package according to the new center discount rate thus calculated and then pseudorandomly select the maximum discount rate for the new transaction negotiation package between these upper and lower discount bounds, as shown in FIG. 4.

Alternatively, the system can select the maximum discount rate for the new transaction negotiation package directly from the time-based discount curve and then adjust the selected maximum discount rate according to parameters and functions described below.

### 5.4 Anticipated Demand

In one implementation shown in FIG. 4, the system can set a maximum discount rate for the new transaction negotiation package based on the reservation date and time specified in the transaction negotiation package. For example, for the restaurant that experiences its greatest traffic on weekends, the system can reduce a center discount rate (and therefore upper and lower discount bounds) for the new transaction negotiation package that specifies a reservation date falling on a Saturday or a Sunday. Similarly, for the restaurant that experiences its greatest traffic during a lunch hour, the system can reduce a center discount rate (and therefore upper and lower discount bounds) for the new transaction negotiation package that specifies a reservation time between 11:30AM and 1:00PM.

The system can also access the restaurant's current reservation calendar to determine whether the restaurant has availability for the user's party at the specified reservation date and time; if not, the system can decline the new transaction negotiation package or suggest an alternate reservation date and/or time for which the restaurant has sufficient availability. If the restaurant does have sufficient availability for the user's party, the system can shift the center discount rate to reflect this. In particular, if the restaurant's reservation calendar indicates the restaurant is at low capacity at the reservation date and time, the system can set a higher center discount rate (or increase the maximum discount rate directly). However, if the restaurant's reservation calendar indicates the restaurant is nearing maximum capacity at the reservation date and time, the system can set a lower center discount rate (or decrease the maximum discount rate directly); in this scenario, the system can also set a negative maximum discount for the new transaction negotiation package, thereby requiring the user to submit an overbid to secure a reservation at the selected date and time responsive to a sufficiently high demand at the restaurant, as indicated by the restaurant's reservation calendar.

The system can then implement methods and techniques described above to define upper and lower discount bounds of discount rates available to the user according to the new center discount rate and then pseudorandomly select the maximum discount rate for the new transaction negotiation package between these upper and lower discount bounds. Alternatively, once the maximum discount rate for the new transaction is selected, such as directly from a discount rate curve, the system can adjust the maximum discount rate based on anticipated demand in the restaurant at the reservation date and time specified in the new transaction negotiation package.

### 5.5 Transaction Size

In the foregoing implementation, the system can: sum a total monetary cost of the selection of menu items in the new transaction negotiation package; and then retrieve a time-based discount curve, from a set of time-based discount curves, associated with a range of total monetary costs containing the total monetary cost of this selection of menu items, as shown in FIG. 4. In particular, the system can access and implement different time-based discount curves based on total transaction costs specified in transaction negotiation packages and then set center discount rates for these transaction negotiation packages accordingly. For example, the system can generate, store, and later access a set of discount curves for the restaurant based on discount parameters entered by a representative of the restaurant through the client portal such as including: a first discount curve for transactions under $10 in total value; a second discount curve for transactions between $10 and $25 in total value, wherein the second discount curve is parallel and offset from (i.e., greater than) the first discount curve (e.g., by 2%); a third discount curve for transactions between $25 and $50 in total value, wherein the second discount curve is parallel and offset from the first discount curve (e.g., by 5%); etc.

In the foregoing example, upon receipt of a new transaction negotiation package from the user, the system can: select a discount curve most relevant to the total cost of menu items specified in the new transaction negotiation package; map the duration of time until the reservation date and time specified in the transaction negotiation package to the selected discount curve to calculate a center discount rate for the new transaction negotiation package; implement methods and techniques described above to define upper and lower discount bounds of discount rates available to the user in the current transaction according to the new center discount rate; and then pseudorandomly select the maximum discount rate for the new transaction negotiation package between these upper and lower discount bounds, as shown in FIG. 4.

Alternatively, the system can set the upper and lower discount bounds for the new transaction directly based on the total cost of menu items specified in the transaction negotiation package. For example, the system can: sum a total monetary cost of the selection of menu items; offset the upper discount bound from the target discount rate set for the vendor by a distance directly proportional to the total monetary cost of the selection of menu items; offset a lower discount bound from the target discount rate by a distance inversely proportional to the total monetary cost of the selection of menu items; and then select the maximum discount rate (e.g., pseudorandomly) from a spectrum of discount rates between the upper discount bound and the lower discount bound.

Yet alternatively, once the maximum discount rate for the new transaction is selected, such as directly from a discount rate curve, the system can adjust the maximum discount rate based on the total cost of items specified in the new transaction negotiation package.

### 5.6 Menu Items

In another implementation, the system adjusts the center discount rate (or the upper and lower discount bounds directly) based on specific menu items listed in this new transaction negotiation package. For example, the system can store margins for each menu item in the digital menu, such as an average or projected margin for individual menu items or for groups of similar menu items (e.g., alcoholic beverages, non-alcoholic beverages, appetizers, salads, meat entrees, fish entrees, desserts, etc.) entered by a representative of the restaurant through the client portal and specifying a particular time of year or season. The system can then assign discount rate adjustment coefficients (e.g., between 0.8 and 1.2) to individual menu items or to groups of like menu items directly proportional to their associated margins. Once a center discount rate and/or upper and lower discount bounds are set for the new transaction, the system can: aggregate discount rate adjustment coefficients for menu items specified in the new transaction negotiation package; calculate a linear combination (e.g., an average) of these discount rate adjustment coefficients; and multiply the center discount rate and/or upper and lower discount bounds by the value of this linear combination. Therefore, the system can increase—on average—the discount rate provided to a user for a transaction negotiation package listing high-margin menu items and decrease—on average—the discount rate provided to a user for a transaction negotiation package listing low-margin menu items. (Alternatively, the system can adjust the maximum discount rate selected for the new transaction in Block S130 directly by multiplying the maximum discount rate by the value of this linear combination.)

In another implementation, for a particular menu item specified in the transaction negotiation package, the system can access a quantity of the particular menu item (or amounts of ingredients necessary to prepare the particular menu item) projected to be available at the restaurant at the specified reservation date and time. For example, the system can account for units of the particular menu item listed in other completed transaction negotiation packages specifying the same reservation date, availability of ingredients in the particular menu item during the current season, etc. The system can then: assign a discount rate adjustment coefficient to the particular menu item inversely proportional to the quantity of the particular menu item projected to be available at the restaurant at the projected reservation time; and adjust the center discount rate, the upper and lower discount bounds, or the maximum discount rate directly for the new transaction negotiation package accordingly.

### 5.7 Real-Time Transaction Frequency

In another implementation, the system can track real-time frequency of transaction negotiation packages specifying the restaurant and then increase the center discount rate for the new transaction with the user inversely proportional to the real-time transaction frequency. The system can then adjust the upper and lower discount bounds accordingly and select a maximum discount rate for the new transaction between these revised upper and lower discount bounds. (Alternatively, once the maximum discount rate for the new transaction negotiation package is selected, the system can adjust the maximum discount rate inversely proportional to the real-time transaction frequency.)

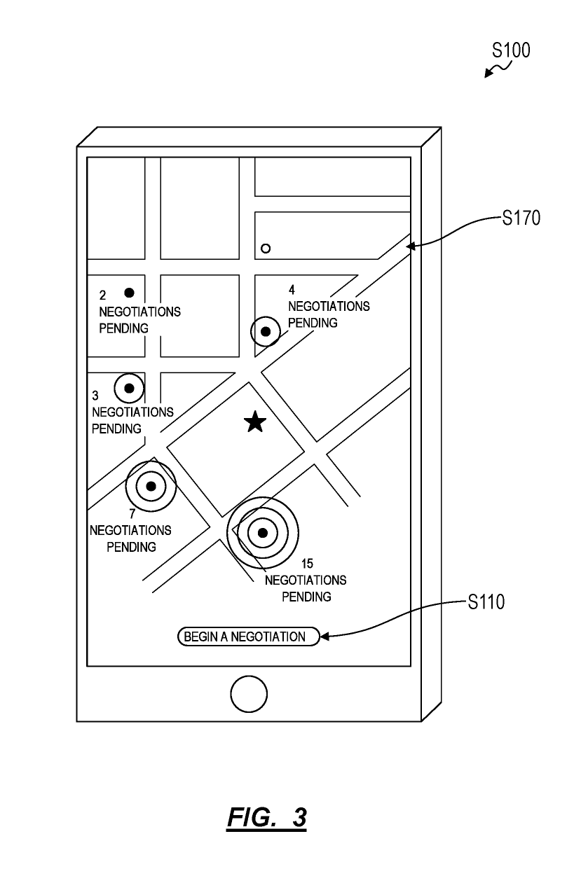

In this implementation, by increasing the center discount rate (or the maximum discount rate directly) inversely proportional to the real-time frequency of transaction negotiation packages specifying the restaurant, the system may achieve a higher success rate across a reduced number of transaction negotiation packages entered during a “quiet” period and thereby maintain a more constant influx of negotiation-based revenues for the restaurant. The system can also maintain a “heatmap” of successful transaction negotiation packages entered over a geographic region, as described below and shown in FIG. 3; by increasing—on average—maximum discount rates provided to users during “quiet” periods, the system may achieve a greater success rate in these transaction negotiation packages, which may then incite other users—through the heatmap—to initiate their own transaction negotiation packages, thereby increasing the frequency of transaction negotiation package submissions.

The system can implement similar methods and techniques to decrease the center discount rate for the new transaction negotiation package directly proportional to the number of outstanding reservations specifying the same or similar reservation date and time as the new transaction negotiation package. For example, the system can decrease the center discount rate—and therefore, on average, the maximum discount rate—for the new transaction negotiation package if a number of outstanding reservations specifying the same date and time at the restaurant exceeds a threshold or average rate; and vice versa in order to maintain low discount rates during high demand hours and high discount rates during low demand hours, thereby instigating a more uniform distribution of reservations at the restaurant over time (e.g., over the course of one day or one week).

The system can then set the upper and lower discount bounds for the new transaction negotiation package based on the adjusted center discount rate and pseudorandomly select a maximum discount rate from this spectrum in Block S130. Alternatively, the system can set the upper and lower bounds directly based on the foregoing parameters or adjust a maximum discount rate—such as selected directly from a discount rate curve—based on the foregoing parameters.

### 5.8 Collated Orders

In another implementation, the system can link the new transaction negotiation package to a group of successful transaction negotiation packages previously submitted and specifying the same reservation date and similar reservation times. By grouping the new transaction negotiation package with these similar transaction negotiation packages, the system can implement methods and techniques described above to calculate a higher basket cost for menu items listed in this group of transaction negotiation packages and then increase the center discount rate for the new transaction negotiation package accordingly. The system can also retroactively increase the final discount applied in the other successful transaction negotiation packages in this group. In particular, because the total negotiation-based revenues of the restaurant on this reservation date have increased with this greater total number of successful transaction negotiation packages, the opportunity cost of providing additional menu items to the new user may decrease; the system can leverage this decreased cost to provide—on average—a greater maximum discount rate to the user in the new transaction negotiation package.

The system can then set the upper and lower discount bounds for the new transaction negotiation package based on the adjusted center discount rate and pseudorandomly select a maximum discount rate from this spectrum in Block S130. Alternatively, the system can set the upper and lower bounds directly based on the foregoing parameters or adjust a maximum discount rate—such as selected directly from a discount rate curve—based on groupings between the new transaction negotiation package and successful transaction negotiation packages specifying similar negotiation dates and times.

### 5.9 Maximum Discount Rate Selection

Once a center discount rate is thus selected and/or modified, the system can calculate upper and lower discount bounds for the new transaction negotiation package. For example, the system can implement preset, static offset values of 8%; for a center discount of 12%, the system can calculate an upper discount of 20% and a lower discount of 4%. Alternatively, the system can calculate offset values for the upper and lower discount bounds, such as: directly proportional to a real frequency of transaction negotiation package submissions; directly proportional to a number of submitted transaction negotiation packages that specify the same reservation date and similar reservation time as the new transaction negotiation package; inversely proportional to a difference between the target discount rate and the actual aggregate discount rate for the restaurant over a period of time; etc. The system can also implement upper and lower discount rate caps, such as 25% and 2%, respectively.

Once a spectrum of discount rates is thus defined for the new transaction negotiation package, the system can pseudorandomly elect a discount rate from within this spectrum and store this discount rate as the maximum discount rate for the new transaction negotiation package. In this implementation, the system can implement a pseudorandom number generator configured to output a uniform distribution of values over time. Alternatively, the system can implement a pseudorandom number generator configured to output a normal (or “Gaussian”) distribution of values over time in order to achieve tighter control over limiting differences between the target discount rate and the actual aggregate discount rate of successful transaction negotiation packages at the restaurant. Similarly, the system can implement a pseudorandom number generator configured to output a skewed normal distribution of values over time, such as skewed toward lower values in order to achieve—on average—lower maximum discount rates selected for transaction negotiation packages over time. Yet alternately, the system can implement a pseudorandom number generator configured to output an inverse bell curve distribution of values over time in order to better obscure the target discount rate for the restaurant from a repeat user. However, the system can implement a pseudorandom number generator configured to output any other distribution of values.

The system can call the pseudorandom number generator for a new value and then map this new value to the bounded spectrum of discount rates to select a maximum discount rate for the new transaction negotiation package in Block S130. However, the system can implement any other method or technique to select a maximum discount rate from a bounded spectrum of discount rates selected for the new transaction negotiation package.

### 6. User Discount History

In one variation, the system can also: retrieve, from the database, a final discount rate of a successful transaction negotiation package specifying the restaurant and previously submitted by the user; and adjust the maximum discount rate to differ from the final discount rate of this previous transaction negotiation package by a threshold rate. Generally, in this implementation, the system can adjust the maximum discount rate selected for the new transaction negotiation package to differ significantly from a last discount applied to a transaction between the same user and the same restaurant in order to further obscure the restaurant's target discount rate set from the user. In particular, the system can check the user's transaction history with the restaurant and adjust the maximum discount rate selected for the new transaction negotiation package to substantially ensure that a discount rate applied to the new transaction negotiation package differs significantly from the discount rate received by the user in a last transaction or in a sequence of (e.g., three) previous transactions with the restaurant.

In a similar implementation, if a previous negotiation performed by the system with the user on behalf of the restaurant yielded a final, agreed-upon discount rate similar to a maximum discount rate selected for the current transaction, such as with a threshold discount difference, the system can adjust the upper and lower discount bounds for the new transaction negotiation package. For example, upon receipt of the new transaction negotiation package, the system can initially set a lower discount bound at 8%, set an upper discount bound at 30%; and retrieve a threshold discount difference between consecutive transactions with the restaurant of 6%. The system can then: determine that a last negotiation between the user and the restaurant resulted in a 25% discount for the user; shift the upper discount bound to 19%; and select a new maximum discount rate that falls between 8% and 19% for the new transaction negotiation package. Similarly, if the last negotiation between the user and the restaurant resulted in a 10% discount for the user, the system can shift the lower discount bound to 16% and select a new maximum discount rate that falls between 16% and 30% for the new transaction negotiation package.

However, the system can adjust or calculate a maximum discount rate for the new transaction negotiation package according to any other parameters.

### 7. Automated Negotiation

Block S140 of the method recites, in response to the initial monetary offer representing an initial discount rate greater than the maximum discount rate, serving a first monetary counter offer through the customer portal, wherein the first monetary counter offer represents a first counter discount rate less than the maximum discount rate. Generally, in Block S140, the system negotiates with the user on behalf of the restaurant to reach an agreed upon discount rate for the menu items listed in the transaction negotiation package, as shown in FIGS. 1 and 2. In particular, in Block S140 the system can: receive offers from the user, such as in the form of absolute monetary values, for the selected menu items; (calculate a discount rate represented in these offers received from the user;) compare discount rates represented in these offers to the maximum discount rate set for the new transaction negotiation package; return counter offers to the user through the customer portal if the user's last offer represents a discount rate that exceeds the maximum discount rate set for the new transaction negotiation package; and accept the user's last offer if the user's last offer represents a discount rate less than the maximum discount rate set for the new transaction negotiation package. The system can also track offer metrics during the negotiation and reject the transaction negotiation package outright if certain metrics are met, such as if a time limit is reached, a threshold number of counter offers are received, progress stalls, or an impolite (i.e., low) monetary offer is provided by the user.

### 7.1 Deceptive Offers

In one implementation shown in FIG. 2, upon receipt of a transaction negotiation package and initiating a negotiation with the user, the system first confirms that the user's initial monetary offer does not represent an extreme discount rate (e.g., “impolite offer”). For example, the system can label an initial offer that represents a discount rate that exceeds the maximum discount rate by more than a threshold difference (e.g., 20%) or exceeds a preset discard threshold (e.g., 35%)—which may indicate that the user is not serious about the transaction negotiation package or is “fishing” for a large discount—as deceptive and cancel the new transaction negotiation package entirely. In a similar example, if the user's initial monetary offer for the menu items listed in the transaction negotiation package represents a first discount rate twice the maximum discount rate set for the transaction, the system can reject the initial monetary offer, cancel the transaction negotiation package entirely, and issue a notification to the user through the client portal that the initial offer has been declined and the transaction negotiation package canceled. Therefore, in response to the initial monetary offer representing a first discount rate exceeding the maximum discount rate set for the transaction negotiation package by more than a threshold proportion of the maximum discount rate, the system can reject the initial monetary offer and cancel the transaction negotiation package, thereby preventing the user from starting with a very low offer in order to trick system into returning its maximum discount rate in its first counter offer in Block 140.

However, the system can implement any other triggers or parameters to automatically cancel the new transaction negotiation package based on the initial monetary offer. Otherwise, if the initial monetary offer passes this initial filter, the system can automatically begin negotiations with the user through the client portal in Block S140.

### 7.2 Initial Discount Rate Exceeds Maximum Discount Rate

In one implementation shown in FIG. 2, in response to the initial monetary offer received with the new transaction negotiation package representing an initial discount rate exceeding the maximum discount rate by less than the threshold proportion of the maximum discount rate or otherwise passing the initial filter described above, the system can calculate a first monetary counter offer that represents a first counter discount rate less than the maximum discount rate. For example, the system can calculate a monetary counter offer representing the lesser of: half of the initial discount rate of the user's initial monetary offer; and the maximum discount rate less a discount buffer (e.g., 8% for a maximum discount of 12% less a discount buffer of 4%; or 9% for a maximum discount of 12% less a discount buffer factor of 0.75). The system can then apply this first counter discount rate to the total transaction cost specified in the new transaction negotiation package to calculate the first monetary counter offer for the negotiation and serve this first monetary counter offer to the user through the customer portal in Block S140.

Alternatively, if the initial monetary offer received with the new transaction negotiation package represents an initial discount rate exceeding the maximum discount rate by less than the threshold proportion of the maximum discount rate or otherwise passing the initial filter described above, the system can immediately return a first monetary counter offer that represents the maximum discount rate to the user; the system can then complete the transaction in Block S150 if the user accepts the first monetary counter offer and cancel the transaction if the user rejects the first monetary counter offer.

However, the system can implement any other method, technique, negotiation model, lookup table, discount buffer, and/or discount buffer factor, etc. to calculate the first counter discount rate.

### 7.3 Counter Offers

Subsequently, in response to rejection of the first monetary counter offer by the user and receipt of a second monetary counter offer from the user via the customer portal, the system can process payment for the selection of menu items specified in the transaction negotiation package according to the second monetary counter offer in Block S150 if the second monetary counter offer represents a second discount rate less than the maximum discount rate, as shown in FIGS. 1 and 2.

However, if the second monetary counter offer represents a second discount rate that still exceeds the maximum discount rate, the system can: implement methods and techniques described above to calculate a third counter discount rate less than the maximum discount rate and greater than the first counter discount rate; such as an average or other linear combination of the maximum discount rate and greater than the first counter discount rate; calculate a third monetary counter offer according to the third counter discount rate; and return this third monetary counter offer to the user through the customer portal. Then, in response to acceptance of the third monetary counter offer by the user through the customer portal, the system can immediately process payment for the selection of menu items according to the third monetary counter offer in Block S150.

The system can repeat this process until the user accepts a counter offer provided by the system and representing a discount rate less than or equal to the maximum discount rate. The system can also repeat this process until: the user provides a counter offer that represents a discount rate less than the maximum discount rate; a maximum limit of counter offers is reached; a negotiation timer expires; the current and last monetary offers provided by the user differ by less than a threshold discount rate (e.g., 2%) (e.g., which may indicate that the system and the user have reached an impasse); etc. at which time the system can cancel the transaction negotiation package.

### 7.4 Initial Discount Rate Less Than Maximum Discount Rate

In one implementation, if the initial offer provided by the user in the new transaction negotiation package represents an initial discount rate that is less than the maximum discount rate set for the transaction negotiation package, the system can automatically accept the initial offer in Block S140 and process the transaction in Block S150.

Alternatively, though the initial discount rate may be less than the maximum discount rate, the system can calculate and return a first counter offer—representing a first counter discount rate less than the initial discount rate—to the user via the customer portal, as shown in FIG. 2. For example, the system can calculate a maximum discount of 12% for the new transaction negotiation package; upon receipt of an initial offer representing a 10% discount, the system can return a first counter offer representing a first counter discount of 9%, which may be a substantially insignificant adjustment for the user but yield a large impact on total revenue for the restaurant over time. In another example, the system can calculate a first monetary counter offer that represents a first discount rate that exceeds the initial discount rate by a preset offset, such as 2% or 5%, and then return this first monetary counter offer to the user through the customer portal. In this implementation, if the user accepts the first monetary counter offer, the system can complete the transaction in Block S150. However, if the user rejects the first monetary counter offer and provides no second counter offer, the system can automatically accept the user's initial monetary offer and complete the transaction accordingly in Block S150. Similarly, if the user rejects the first monetary counter offer and provides a second counter offer representing a second counter discount rate between the initial discount rate and the first discount rate, the system can automatically accept the user's second original monetary offer and complete the transaction accordingly in Block S150.

However, the system can implement any other methods or techniques in Block S140 to automatically negotiate with the user on behalf of the restaurant.

### 8. User Sincerity

In one variation, the system also gauges the user's sincerity or interest in reaching a successful negotiation for the transaction negotiation package and adjusts negotiation parameters accordingly.

### 8.1 Location

In one implementation, the system: detects a location of the computing device, such as by requesting a geospatial coordinate of the user's computing device; calculates a distance between the location of the computing device and a known location of the restaurant specified in the transaction negotiation package; and then adjusts the maximum discount rate for the transaction negotiation package inversely proportional to this distance if the reservation time and the reservation date specified in the transaction negotiation package fall within a threshold time from a current time. Generally, in this implementation, the system can correlate the user's sincerity with the real distance between the user (i.e., the user's computing device) and the restaurant and then adjust the maximum discount rate for the transaction negotiation package based on this perceived sincerity. For example, if the reservation date and time specified in the transaction negotiation package is substantially immediate (e.g., within the next ten minutes, within the next two hours, or within another threshold duration of time), the system can: predict that the user is sincerely interested in completing a transaction with the restaurant if the user is within a threshold distance (e.g., six blocks or one mile) of the restaurant; increase the center discount rate (i.e., shift the upper and lower discount bounds) or the maximum discount rate directly, such as by 4%, for the transaction negotiation package in Block S130; and then negotiate the transaction negotiation package with the user on behalf of the restaurant accordingly. The system can therefore provide a greater maximum discount rate to the user if the transaction negotiation package specifies a reservation date and time in the near future and the user is physically near the restaurant.

### 8.2 User Completion Rate

In another implementation, the system can generate and subsequently retrieve a “user completion rate”—including a ratio of a number of negotiations successfully completed by the user over a period of time (e.g., within a past week, month, quarter, or year, etc.) versus a number of negotiations initiated by the user over the same period of time—from a database and then modify negotiation rules implemented in Block S140 based on this user completion rate. In this variation, the system can retrieve or calculate a user completion rate specific to the restaurant specified in the new transaction negotiation package, specific to restaurants near (e.g., within a threshold distance of) the restaurant specified in the transaction negotiation packages, or for all restaurants noted in transaction negotiation packages previously submitted by the user.

In this implementation, the system can then set a maximum number of permitted counter offers received from the user during a negotiation of the transaction negotiation package in Block S140 based on the user completion rate. In particular, the system can: retrieve a rate of successful outcome across a set of transaction negotiation packages previously submitted by the user (i.e., the “user completion rate”); set a threshold number of monetary offers to trigger cancelation of the transaction negotiation package directly proportional to the rate of successful outcome; maintain a count of monetary offers received from the user during negotiation of the transaction negotiation package; and then automatically cancel the transaction negotiation package if the count of monetary offers received from the user for the transaction negotiation package exceeds a threshold number of offers prior to receipt of a monetary offer representing a discount rate less than the maximum discount rate selected for the transaction negotiation package. For example: if the user's completion rate is less than 50%, the system can set a threshold of two monetary offers (e.g., the initial offer and a second counter offer); if the user's completion rate is between 50% and 75%, the system can set a threshold of three monetary offers (e.g., the initial offer, a second counter offer, and a fourth counter offer); if the user's completion rate is between 75% and 90%, the system can set a threshold of four monetary offers; and, if the user's completion rate is greater than 90%, the system can set a threshold of five monetary offers. Therefore, because users with higher completion rates may have historically taken transaction negotiation packages and their negotiation seriously (and may be more likely to work toward success completion of a next transaction negotiation package), the system can reward these users with more negotiation opportunities through more negotiation rounds. (Alternatively, the system can set threshold counter offers inversely proportional to user completion scores in order to better engage users with low user completion scores and limit insight into target discount rates for users with greater user completion scores.

In a similar example, if the user's completion rate is less than 50%, the system can set a threshold of two monetary offers (e.g., the initial offer and a second counter offer); if the user's completion rate is between 50% and 75%, the system can set a threshold of three monetary offers (e.g., the initial offer, a second counter offer, and a fourth counter offer); if the user's completion rate is between 75% and 90%, the system can set a threshold of four monetary offers; and, if the user's completion rate is greater than 90%, the system can set a threshold of one monetary offer. Therefore, the system can reward users with higher completion rates up to a point and then drastically reduce a threshold offer count in order to reduce chances of success for users with the highest completion rates and to maintain user completion rates near a preset target success rate (e.g., 80%) for frequent users.

In another implementation, the system can set a timer for a total duration of the negotiation for the new transaction negotiation package proportional to the user's completion rate. For example, the system can reward users with higher completion rates with more time to complete a new negotiation within the system. For example, if the user's completion rate is less than 50%, the system can set a 30-second negotiation timer; if the user's completion rate is between 50% and 75%, the system can set a one-minute negotiation timer; if the user's completion rate is between 75% and 90%, the system can set a two-minute negotiation timer; and, if the user's completion rate is greater than 75%, the system can set a three-minute negotiation timer. Alternatively, an higher user completion rate may suggest greater interest and willingness to accept a lower discount rate, so the system can set a negotiation duration inversely proportional to the user completion rate, thereby requiring a high-success-rate user to enter counter offers or to accept an existing offer in less time, which may lead to acceptance of a monetary counter offer representing a lower discount rate.

In a similar implementation, the system can adjust a delay time between receipt of an initial or counter monetary offer from the user and delivery of a response to these monetary offers through the customer portal based on the user's completion rate. For example, if the user's completion rate is less than 50%, the system can set a 10-second delay between receipt of a monetary offer and service of a reply to the user; if the user's completion rate is between 50% and 75%, the system can set a 7-second delay; if the user's completion rate is between 75% and 90%, the system can set a 3-second delay; and, if the user's completion rate is greater than 75%, the system can set an intended delay of null. For a user with a low completion rate, the system can institute longer delay times in order to increase the user's anxiety or anticipation during the negotiation, thereby improving a possibility that this user will accept a next offer. As the user shows greater interest in negotiating with the system over time and completes a higher rate of negotiations, the system can reduce a delay time for this user.

In another implementation, the system can adjust a negotiation intensity (or “how hard the system pushes for lower discount rates”) based on the user's completion rate. In this implementation, when selecting a monetary counter offer to serve to the user in Block S140, the system can skew the counter discount rate represented by the monetary counter offer more toward null and directly proportional to the user's completion rate. For example, after receiving an initial monetary offer from the user, returning a first monetary counter offer to the user, and then receiving a second monetary counter offer from the user, the system can: select a third monetary counter offer that represents a third counter discount rate between the second counter discount rate and the maximum discount rate set for the transaction negotiation package but skewed toward the second counter discount rate directly proportional to the rate of success. Therefore, the system can push for lower discount rates over a greater number of monetary counter offer cycles for users with greater completion rates, and vice versa.

In the foregoing implementation, because a higher user completion rate may indicate that a user is more sincere and/or more willing to accept a lesser discount rate, the system can approach a maximum discount rate selected for a new transaction negotiation package with a high-success-rate user more slowly and can reach this maximum discount rate over more monetary counter offer cycles. Specifically, though the maximum discount rate selected for the transaction negotiation package in Block S130 is still available to the high-success-rate user, the system may require that the user provide greater effort to achieve this discount rate over additional monetary counter offer cycles. Similarly, because a lower user completion rate may indicate that a user is less sincere or less willing to accept a lower discount rate, the system can attempt to improve the user's completion rate by more rapidly approaching the maximum discount rate selected for the transaction negotiation package (i.e., over fewer monetary counter offer cycles). The system can implement these methods and techniques in order to manipulate user completion rates across a group of users toward a target user completion rate (e.g., 80%), thereby preventing high-success-rate users from learning and ultimately gaming the system while preserving (and growing) interest in the system among users with lower completion rates.

The system can implement similar methods and techniques in Block S130 to increase a maximum discount rate for the new transaction negotiation package directly proportional to a number of successful past negotiations between the user and the restaurant specified in the new transaction negotiation package. In particular, the system can set a higher maximum discount rates for new transaction negotiation packages submitted by users who have successfully negotiated greater numbers of transaction negotiation packages in the past.

### 9. Manual Negotiation

In one variation, the system can transition out of automated negotiation in Block S140 and enable a representative of the restaurant to negotiate with the user remotely and in real-time through the client and customer portals. In this variation, the system can implement various rules for passing the transaction negotiation package to a human for manual negotiation. For example, the system can transition the transaction negotiation package to manual negotiation if a difference between the maximum discount rate for the new transaction negotiation package and a discount rate represented by a final monetary offer submitted by the user differ by less than a threshold discount rate (e.g., 2%). In another example, the system can transition the transaction negotiation package to manual negotiation if an agreement was not reached with the user prior to a trigger to cancel the new transaction negotiation package and that specifies a total transaction cost exceeding a preset threshold value (e.g., $100).

In this variation, when a rule for transitioning to manual negotiation is met, the system can: notify the user through the customer portal that the negotiation will be paused; serve a notification to the client portal associated with the restaurant; and then enable direct negotiation between the customer and client portal once the notification at the client portal is selected. The system can also provide a negotiation history with initial offer and counter offer values, initial and counter discount rates, user transaction history with the restaurant and/or other restaurants, and/or menu item and reservation data contained in the transaction negotiation package, etc. to the client portal. The system can also enable tools for sending new monetary counter offers to the user, sending textual prompts to modify various parameters of the transaction negotiation package, calculating counter offer discount rates, and accepting or canceling the transaction negotiation package. Once the user or the representative of the restaurant accepts or cancels the transaction negotiation package through their customer and client portals, respectively, the system can process or discard the transaction negotiation package accordingly.

### 10. Process Transaction

Block S150 of the method recites, in response to acceptance of the monetary counter offer by the user through the customer portal, processing payment for the selection of menu items according to the accepted monetary counter offer. Generally, if the transaction negotiation package is confirmed (i.e., successfully negotiated) in Block S140, the system can process payment for the transaction negotiation package according to the final terms of the negotiation in Block S150, as shown in FIG. 1. For example, once the transaction negotiation package is confirmed in Block S140, the system can immediately initiate payment to the restaurant—via payment information collected from the user in Block S110—according to the final accepted monetary value. Therefore, though the transaction negotiation package may specify a reservation several hours, days, or even weeks in the future, the system can initiate payment to the restaurant for menu items specified in the transaction negotiation package substantially soon after the transaction negotiation package is confirmed.

### 11. Unsuccessful Negotiation

In one variation, if negotiation of the transaction negotiation package is unsuccessful (i.e., the user does not accept a final monetary counter offer provided by the system or the user does not provide a final monetary counter offer that represents a discount rate less than or equal to the maximum discount rate selected for the new transaction negotiation package), the system can suggest to the user adjustments to the transaction negotiation package that may enable the system and the user to reach an agreement. In particular, the system can provide additional negotiation prompts other than monetary counter offers to the user through the customer portal during or after the negotiation in Block S140. Generally, in this variation, if the system is unable to reach an agreement with the user before a trigger to cancel the transaction negotiation package is reached, the system can suggest an alternate date, time, total transaction cost, or menu item selection that would enable the system to provide a discount rate at or nearer the discount rate represented in a last monetary counter offer submitted by the user while also fulfilling discount rate rules predefined for the restaurant.

### 11.1 Alternate Reservation Date and Time

In one implementation, if the system is unable to reach an agreement with the user before a trigger to cancel the transaction negotiation package, the system can suggest that the user select an alternate reservation date and/or time in order to receive a higher discount rate or a discount rate more in-line with the last counter offer submitted by the user. For example, the system can suggest a specific reservation date or reservation time during which the restaurant is projected to be less busy or that is further in the future to enable a greater discount rate according to a predefined discount rate curve for the restaurant. In this example, if the user has requested a 25% discount for a set of menu items on Friday evening and predefined discount rules for the restaurant specify maximum discount of 18% on Friday evenings, 23% on Saturday evenings, and 28% on Sunday evenings, the system can serve a prompt to the user—through the customer portal—to adjust the reservation date in the transaction negotiation package to a Sunday evening in order to redeem the requested 25% discount. If the user declines this prompt, the system can then suggest to the user an adjusted reservation date in the transaction negotiation package to a Saturday evening, serve a discount of 23% to the user, and process the transaction at the 23% discount if the user then adjusts the reservation date to Saturday evening.

### 11.2 Alternate Transaction Cost

In another implementation, the system can prompt the user to increase the transaction cost in order to receive the requested discount rate. For example, if the user requests a 20% discount for a $50 transaction but the predefined discount rules for the restaurant specify a maximum discount of 14% for this transaction, as described above, the system can serve a prompt to the user suggesting an increase in the transaction cost to $75 in order to receive the requested 20% discount. In this example, if the transaction negotiation package lists a bottle of wine, the system can suggest an alternate, more expensive bottle of wine in order to increase the total transaction cost to a level needed to accept the user's requested discount rate. Similarly, in this example, if the list of menu items in the transaction negotiation package excludes an appetizer and/or a dessert, the system can suggest that the user append the selection of menu items with an appetizer and/or a dessert in order to increase the transaction cost to a level sufficient to provide the requested discount rate to the user according to predefined discount rules.

### 11.3 Alternate Reservation Date and Time

In another implementation, the system can suggest an alternative restaurant nearby. In this implementation, the system can scan a list of known restaurants for a set of restaurants near the restaurant originally specified in the original transaction negotiation package. For example, the system can identity a set of restaurants located on the same block or within walking distance of the original restaurant, such as if the reservation time specified in the original transaction negotiation package is imminent. In another example, the system can identify a set of restaurants within a threshold distance (e.g., two miles) of the original restaurant if the reservation time specified in the original transaction negotiation package is more than one hour from the current time.

The system can then filter this set of restaurants down to a subset of relevant restaurants. For example, the system can filter this set of restaurants by: a cuisine or genre of food (e.g., American, Italian, Mexican, etc.) that is substantially similar to that of the original restaurant; restaurants providing a set of menu items that substantially match (e.g., by title, description, and/or keywords) menu items specified in the original transaction negotiation package; restaurants providing menu items in similar price ranges as the original restaurant; restaurants receiving similar (or better) online reviews as the original restaurant; and/or restaurants noted as open on the reservation date and time specified in the original transaction negotiation package; etc. In this example, the system can filter the set of restaurants based on any one or more of the foregoing parameters, such as by prioritizing restaurant style followed by price range, distance, and then reviews, etc. to identify a limited number of (e.g., three) relevant alternative restaurants.

For each relevant alternative restaurant, the system can implement methods and techniques described above to calculate a maximum discount rate for the user given parameters from the original transaction negotiation package; the system can then compare the final monetary counter offer entered by the user during the negotiation in Block S140 to the maximum discount rate calculated for each relevant alternative restaurant. If the maximum discount rate for a particular alternative restaurant exceeds the discount rate represented in the final monetary counter offer entered by the user during the negotiation, the system can present this alternative restaurant and new terms of this deal to the user through the customer portal, such as including the name and location of the alternative restaurant, the date and time of a reservation at the alternative restaurant, a total cost equivalent to (or round to a nearest $5 or $10 interval of) the original total transaction cost of menu items specified in the original transaction negotiation package, and a discounted offer for this total transaction cost. The system can also defer negotiation of these new terms entirely and process this transaction immediately according to these new terms in Block S150 if the user agrees to this new deal.

However, if the maximum discount rates for multiple alternative restaurants exceed the discount rate represented in the user's final monetary counter offer, the system can: select the most relevant of these alternative restaurants, such as based on the prioritized parameters or rankings described above; present this most relevant alternative restaurant and terms of this new deal to the user through the customer portal; defer negotiation of this new deal; and process the transaction according to these new terms in Block S150 if the user accepts this new deal. Furthermore, if the user declines this new deal with the most relevant alternative restaurant, the system can repeat this process for the second alternative restaurant.

Furthermore, if the user agrees to an alternative restaurant, the system can prompt the user to populate an order of menu items for this revised transaction negotiation package, such as through a virtual menu presented to the user through the customer portal, as described above. The system can also recommend or automatically select particular menu items in the alternative restaurant's menu that are similar to menu items specified in the original transaction negotiation package. For example, the system can implement natural language processing or other textual recognition and comparison techniques to match menu items specified in the original transaction negotiation package to menu items listed in the alternative restaurant's menu. The system can revise the original transaction negotiation package to reflect the alternative restaurant and the alternative set of menu items selected from the alternative restaurant's menu before passing the revised transaction negotiation package to the alternative restaurant.

Alternatively, upon identification of a relevant alternative restaurant, the system can: serve a notification to the user through the customer portal to inform the user that the alternative restaurant may be better suited to meet the user's timing needs and budget; implement similar methods and techniques to prompt the user to select an alternative set of menu items from the alternative restaurant's menu as shown in Block S110; calculate a new maximum discount rate for this revised transaction negotiation package as in Block S130; negotiate a monetary offer for this revised transaction negotiation package with the user as shown in Block S140; and process a transaction between the user and the alternative restaurant as shown in Block S150 pending a successful negotiation for the revised transaction negotiation package.

However, the system can provide any other prompts to the user—substantially in real-time during automated negotiation of the transaction negotiation package—to modify parameters of the transaction negotiation package to enable the system to both provide the user's requested discount rate while also fulfilling predefined discount rules.

### 14. Options

In one variation, the system implements methods and techniques similar to those described above to negotiate purchase of an option, at a future time, to purchase an amount of goods from a restaurant at a reduced cost. For example, the system can negotiate with a user to purchase now (e.g., for $5 now) an option to receive a selection of menu items of greater cost (e.g., $50) from a restaurant at a reduced cost (e.g., $40) in the future, such as within a threshold period of time (e.g., one week) or on a particular day and at a particular time (e.g., next Saturday at 7PM). (If the user does not fulfill time requirements specified in this option, the restaurant can retain payment for the option.) In this example, the system can access actuarial tables to set option parameters that predict a net revenue gain for the restaurant and/or to a total discount rate provided to customers over a period of time—accounting for option purchase cost—that approximates or remains less than the target discount rate set by the restaurant.

In one example, if a user has a first date scheduled on a following Friday at 8PM but is not aware of his date's food preferences, the user can interface with the system through a customer portal executing on his smartphone to negotiate and buy a $3 option to purchase $100 worth of food for $80 at each of three restaurants within walking distance of one another. On the night of the date, the user and his date can select the first of these three restaurants where the user purchased an option for $100 worth of food for $80, and the first restaurant can provide $100 worth of food to the user and his date for an additional $80 according to the user's option; the second and third restaurants can retain the $3 paid by the user to purchase these other options. Therefore, in this example: the user may receive $100 worth of food from the first restaurant for a total spend of $89; the first restaurant may receive $83 (less various transaction fees) for $100 of food provided to the user and his date, which amounts to a 17% discount that falls within a target discount rate of 18% set by the first restaurant; and the second and third restaurants receive $3 without providing anything further to the user or his date.

In this variation, the system can calculate a maximum discount rate for a new transaction negotiation package—that specifies an option purchase—as described above. The system can then reference an actuarial model (and a user transaction history with the restaurant) to calculate a discount rate adjustment coefficient (e.g., between 1.0 and 1.3) that accounts for a possibility or likelihood that the user will not exercise the negotiated option and adjust the maximum discount rate according to the discount rate adjustment coefficient. The system can also set an option cost for the new transaction negotiation package based on the actuarial model, such as: 3% of the total cost of menu items specified in the new transaction negotiation package; 5% of the current monetary offer for these menu items; or the discount rate adjustment coefficient in excess of “1.0” crossed with the current monetary offer for these menu items. The system can then implement methods and techniques described above to negotiate a final monetary offer for the option. In this implementation, the system can hold the option cost static or adjust the option cost with each new monetary offer for the transaction negotiation package. Furthermore, the system can enable the user to adjust the option cost, such as by increasing the option cost directly proportional to the discount rate represented by each new monetary offer for the transaction negotiation package.

In this variation, upon agreement between the user and the system for a discount rate and/or an option cost, the system can process payment for the option cost only and provide the user—through the customer portal or other electronic communications—an option code to redeem the option at the restaurant.

However, the system can implement any other methods or techniques to automatically negotiate purchase of an option from a restaurant.

15. Transaction Basket v. Individual Item

The system is described above as executing Blocks of the method to negotiate a discounted monetary offer for a group of menu items listed on a restaurant's menu. However, the system can implement similar methods and techniques to negotiate a discounted monetary offer for a single menu item or for a subset of menu items provided by a restaurant. For example, upon receipt of a transaction negotiation package that specifies both food items (e.g., appetizer, entrée, and dessert) and alcoholic beverages, the system can: separate the food items from the alcoholic beverages; automatically handle a first negotiation with the user for the food items according to a target discount rate set by the restaurant for food items; and automatically handle a separate negotiation with the user for the alcoholic beverages according to a separate target discount rate set by the restaurant for alcoholic beverages.

The system can also implement similar methods and techniques to negotiate a discounted monetary offer for a total value of goods provided by a restaurant. For example, a user can submit a transaction negotiation package offering $40 for $50 worth of goods from a restaurant, and the system can implement methods and techniques described above to set a maximum discount rate for the transaction negotiation package and to automatically negotiate with the user through the user's customer portal on behalf of the restaurant.

Furthermore, the system can automatically negotiate one transaction negotiation package submitted by the user across multiple restaurants substantially simultaneously. For example, when population parameters of a new transaction negotiation package, the user can select: all restaurants in a two-block radius of a particular location; all restaurants along a city block; all restaurants serving Italian food with a bounded location (e.g., quarter-mile radius); all restaurants serving associated with similar price ranges (e.g., “$,” “$$,” “$$$,” or “$$$$” price ranges); etc. In this example, the user can also enter an offer of $40 for $50 worth of goods into the new transaction negotiation package. The system can then implement methods and technique described above to calculate a maximum discount rate for each restaurant indicated in the transaction negotiation package, to perform a single negotiation with the user as described above, and to confirm the transaction negotiation package for a single restaurant specified in the transaction negotiation package. Alternatively, in this example, the system can confirm the transaction negotiation package for a subset of restaurants specified in the transaction negotiation package for which a final offer entered or accepted by the user fulfills maximum discount rates set for this subset of restaurants; the user can then redeem goods from any restaurant in this subset according to final terms of the transaction negotiation package. Yet alternatively, in this example, the user can rank the set of restaurants specified in the transaction negotiation package, and the system can sequentially negotiate terms of the transaction negotiation package with the user on behalf of each of the restaurants—in order of rank—until terms of the transaction negotiation package are successfully negotiated on behalf of a particular restaurant in this set. The user can then redeem goods from the particular restaurant according to these final terms.

However, the system can implement any other method or technique to automatically negotiate purchase of a single menu item, a group of menu items, or a multi-course meal of menu items by the user.

### 16. Over Bidding

In another variation, the system can enable the user to enter a monetary offer for a selection of menu items—specified in a new transaction negotiation package—that exceeds a total list price of these menu items (hereinafter an “overbid”). For example, the user can enter an overbid through the customer portal for a single menu item or set of menu items including a rare, exclusive, low-supply, or highly-seasonal product, such as a limited release bottle of wine, a side of fish in limited stock at the selected restaurant, or oysters near the end of oyster season. By submitting an overbid, the user can: guarantee (or anticipate with greater certainty) that her selected items will be available on the reservation date and time specified in the new transaction negotiation package; and incentivize the restaurant to acquire materials necessary to fulfill this order in advance of the user's reservation while limiting or eliminating risk to the restaurant in attaining these materials. In particular, a restaurant may not always be capable of guaranteeing that a menu item will be available in advance, such as the following week; however, by submitting an overbid in sufficient advance of a reservation date (i.e., given sufficient time and financial incentive), the restaurant may take steps to better ensure that the menu item requested and pre-paid for by the user via an overbid is available when the user arrives at the restaurant at the reserved time.

In another implementation, users may propose overbids through their respective customer portal in exchange for reservations at a restaurant during high-traffic periods. In this example, if a restaurant is often at full capacity on Saturday evenings between 7:30 and 11PM, a first user can populate a first transaction negotiation package with a Saturday evening reservation and a selection of menu items with a total list price of $200 two weeks in advance in Block S110; the system can then negotiate with the first user for a final monetary offer of $190 for the first transaction negotiation package given that the current reservation capacity at the restaurant at the specified date and time is 50%. In this example, second user can populate a second transaction negotiation package with a Saturday evening reservation, a selection of menu items with a total list price of $200, and an initial monetary offer of $205 one week in advance, in Block S110; given that the current reservation capacity at the restaurant at the specified date and time is 85%, the system can automatically accept the initial monetary offer of $205 (or automatically attempt to negotiate the second transaction negotiation package to $210). A third user can later populate a third transaction negotiation package with a Saturday evening reservation, a selection of menu items with a total list price of $200, and an initial monetary offer of $250 two days in advance, in Block S110; given that the current reservation capacity at the restaurant at the specified date and time is 95%, the system can automatically reject the initial monetary offer of $250 and serve a counter monetary offer of $300 before accepting a final monetary counter offer of $285. Finally, a fourth user may arrive at the restaurant—with no reservation—on the same Saturday evening as specified in the first, second, and third transaction negotiation packages. The system can indicate to the fourth user—through a corresponding customer portal accessed through the fourth user's smartphone—that the restaurant will have capacity for the fourth user's party within fifteen minutes. To secure this table, the fourth user can populate a fourth transaction negotiation package with the corresponding reservation date and time, a selection of menu items with a total list price of $200, and an initial monetary offer of $250 for this immediate reservation in Block S110; the system can then accept this offer immediately based on historical data that suggests that receipt of a higher bid before the table opens is unlikely.

The system can therefore negotiate “negative” discount rates based on real-time or predicted demand at the restaurant, as described above. However, the system can implement any other methods or techniques to handle, process, and negotiation overbids.

### 17. Heatmap

In one variation shown in FIG. 3, the system further generates a real-time “heatmap” of submitted transaction negotiation packages and/or successful transaction negotiation packages by location of users and/or participating restaurants and serves this heatmap—in digital graphical form—to a user's customer portal in order to inform the user about which restaurants in certain locations are currently negotiating with customers via the system. For example, the system can color code areas on the virtual geospatial map by transaction negotiation package frequency to generate the heatmap and then serve the heatmap to the user through the user's customer portal.

In this variation, the method can further include Block S170, which recites: detecting a location of the user's computing device; accessing a virtual geospatial map of the user's location; indicating a set of restaurants proximal the user's location; populating the virtual geospatial map with visual representations of a frequency of successful transaction negotiation packages and specifying restaurants in the set of restaurants represented in the virtual geospatial map; and then serving the virtual geospatial map to the computing device for rendering within the customer portal. Generally, in this implementation, the system can populate the virtual geospatial map with indicators of other negotiations occurring around the user or around the restaurant specified in the transaction negotiation package submitted by the user in Block S110, as shown in FIG. 3. The system can also repeat this process regularly—such as once per 30-second interval following receipt of each new transaction negotiation package—to provide a real-time view of local restaurants accepting transaction negotiation packages and/or real-time acceptance rates of these transaction negotiation packages.

Furthermore, in this implementation, the system can apply filters to this heatmap, such as time or transaction size filters. For example, the system can refine the heatmap for the user to show all negotiations currently in process and occurring within a threshold period of time (e.g., within ten minutes of, within one hour of, or on the same day as) of the current time. The system can also refine the heatmap to show all attempted and/or successful negotiations specifying a reservation date and time within a threshold time (e.g., within two hours of, or on the same day as) the reservation date and time specified in the new transaction negotiation package submitted by the user (or in process in the user's customer portal). The system can additionally or alternatively refine the heatmap to show transaction negotiation packages specifying total transaction amounts similar to the total transaction amount of the new transaction negotiation package submitted by the user.

Therefore, the system can refine a heatmap specifically for the user to show other transaction negotiation packages specifying: restaurants in similar locations as the restaurant listed in the user's transaction negotiation package; transaction negotiation packages specifying total transaction costs similar to that of the user's transaction negotiation package; reservation dates and times similar to those of the user's transaction negotiation package; etc. The system can then serve this customized heatmap to the user through the user's customer portal in Block S170. The system can also enable the user to initiate a new transaction negotiation package by selecting a restaurant or area within the heatmap.

### 18. Processing at Restaurant

Block S160 of the method recites transmitting the reservation date, the reservation time, and the selection of menu items to the restaurant. Generally, in Block S160, the system serves data from a confirmed transaction negotiation package to the corresponding restaurant for processing and handling, as shown in FIGS. 1 and 2.

In one implementation, the system serves transaction negotiation package data to the restaurant immediately following confirmation of a final monetary offer between the user and the system and following payment for the transaction negotiation package according to this final monetary offer. The system can additionally or alternatively distribute data from the confirmed transaction negotiation package to one or more restaurant-related systems over a period of time between negotiation of the transaction negotiation package and the reservation date and time specified in the transaction negotiation package. For example, upon confirmation of payment for the selection of menu items, the system can serve a restaurant code, the user's name, the user's party size, the reservation date, and/or the reservation time, etc. to a reservation platform internal to or external to the restaurant for recordation of the user's reservation at the restaurant.

The system can later inject the selection of menu items into the restaurant's internal electronic order placement system. In one implementation, the system can insert a first menu item—in the selection of menu items—into a position within the restaurant's electronic order placement system corresponding to a time preceding the reservation time by a preset preparation time for the first menu item, less a preset buffer time from the reservation time to target delivery of menu item to the user. For example, if paella or risotto—which may require more time to prepare—are specified in the confirmed transaction negotiation package, the system can transmit an order for this menu item to the restaurant's electronic order placement system for insertion into the restaurant's order queue at a position enabling the restaurant to start preparation of the menu item prior to the user's reservation time. In this example, the system can also label the menu item with a target preparation start time that precedes the reservation time to ensure that menu item is ready for the user within a threshold time following her arrival at the restaurant at the reservation time.

In the foregoing example, the confirmed transaction negotiation package specifies fried calamari for an appetizer, paella for an entrée, and a reservation time of 8PM. The system can thus retrieves—from a remote database—preparation times for these menu items set by the restaurant, including a preparation time of ten minutes for fried calamari and 45 minutes for paella. The system can also retrieve a target delivery appetizer time of one minute from a reservation time for appetizers and a target entrée delivery time of fifteen minutes following delivery of an appetizer—such as set by the restaurant through the client portal—from the remote database. The system can then inject an order for paella into the restaurant's electronic order placement system at 7:30PM and inject an order for fried calamari into the restaurant's electronic order placement system at 7:50PM in order to meet these target food delivery times for the user's reservation time of 8PM.

The system can additionally or alternatively track the geospatial location of the user's computing device leading up to the reservation time specified in the confirmed transaction negotiation package and then inject orders for specified menu items into the restaurant's electronic order placement system based on the user's distance from the restaurant, such as once the user is within four city blocks, 500 meters, or ten minutes from the restaurant. Alternatively, the system can tag menu items specified in the confirmed transaction negotiation package with the user's name (or party identifier), the reservation date, the reservation time, and/or a preparation start time preceding the reservation time by a static buffer time (e.g., ten minutes) and then serve this list of tagged menu items to the restaurant's client portal or directly to the restaurant's electronic order placement system.

However, the system can serve data from the confirmed transaction negotiation package to the restaurant or to any other external system affiliated with the restaurant—such as via email, web-accessible spreadsheet, or facsimile transmission—in Block S160.

### 19. Other Applications

As described above, the system can implement similar methods and techniques to automatically negotiate discounts for one good or for a basket of goods with a user through a customer portal on behalf of a vendor or other business entity that may provide these goods based on target discount rates and other parameters set by the business entity. For example, the system can implement methods and techniques described above to negotiate a new transaction negotiation package specifying a grocery store, a basket of groceries, a pickup or delivery time for the basket of groceries, and an initial offer for the basket of groceries; upon successful negotiation and payment for this transaction negotiation package, the system can serve details of the transaction negotiation package to the grocery store, which can then package the listed groceries prior to the selected pickup time or dispatch the listed groceries for delivery to the user around the selected delivery time.

In another example, the system can implement methods and techniques described above to negotiate a new transaction negotiation package specifying a consumer products store, a basket of consumer products (e.g., a television, audio equipment, clothing, shoes, jewelry, etc.), a pickup or delivery time for the basket of consumer products, and an initial offer for the basket of consumer products; upon successful negotiation and payment for this transaction negotiation package, the system can serve details of the transaction negotiation package to the consumer products store, which can then package the listed consumer products prior to the selected pickup time or dispatch the listed consumer products for delivery to the user around the selected delivery time.

In yet another example, the system can implement methods and techniques described above to negotiate a new transaction negotiation package specifying: a golf course; a basket including a green free for eighteen holes; a golf club and golf cart rental; a sleeve of golf balls; a tee time; and an initial offer for the basket. Upon successful negotiation and payment for this transaction negotiation package, the system can serve details of the transaction negotiation package to the golf course, which can then prepare physical items in the basket for the user upon arrival at the selected golf course and tee time.

However, the system can implement these methods and techniques to automatically negotiate discounts, for one or a more goods, with a user on behalf of any other business entity.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for automating negotiation of goods comprising:
initiating a transaction negotiation package based on a restaurant, a reservation date, a reservation time, a selection of menu items, and an initial monetary offer for the selection of menu item selected by a user through a customer portal executing on a computing device;
retrieving, from a database, a target discount rate associated with the restaurant and an aggregate discount rate of final discount rates negotiated for a set of transactions completed with the restaurant over a preceding period of time;
selecting a maximum discount rate for the transaction negotiation package based on a difference between the preset target discount rate and the aggregate discount rate;
in response to the initial monetary offer representing an initial discount rate greater than the maximum discount rate, serving a first monetary counter offer through the customer portal, the first monetary counter offer representing a first counter discount rate less than the maximum discount rate;
in response to acceptance of the first monetary counter offer by the user through the customer portal, processing payment for the selection of menu items according to the first monetary counter offer; and
transmitting the reservation date, the reservation time, and the selection of menu items to the restaurant.

2. The method of claim 1, wherein initiating the negotiation package comprises:
serving a digital list of menu items offered by the restaurant through the customer portal;
receiving the selection of menu items in the digital list from the user through the customer portal;
summing a total cost of the selection of menu items based on individual prices assigned to menu items in the digital list; and
receiving the initial monetary offer proposing a reduced cost of the selection of menu items from the user through the customer portal.

3. The method of claim 1, wherein selecting the maximum discount rate for the transaction negotiation package comprises:
in response to the aggregate discount rate exceeding the preset target discount rate, setting a center discount rate below the preset target discount rate;
in response to the preset target discount rate exceeding the aggregate discount rate, setting the center discount rate for the transaction negotiation package above the preset target discount rate;
calculating an upper discount bound offset from the center discount rate by a static discount rate for the transaction negotiation package;
calculating a lower discount bound offset from the center discount rate by the static discount rate for the transaction negotiation package; and
pseudorandomly selecting the maximum discount rate between the upper discount bound and the lower discount bound.

4. The method of claim 3, wherein setting the center discount rate comprises implementing closed-loop feedback techniques to shift the center discount rate from the preset target discount rate based on a difference between the aggregate discount rate and the preset target discount rate for the restaurant.

5. The method of claim 1, wherein selecting the maximum discount rate for the transaction negotiation package comprises:
retrieving, from the database, a final discount rate of a successful transaction negotiation package specifying the restaurant and previously submitted by the user; and
selecting the maximum discount rate that differs from the final discount rate by a threshold rate.

6. The method of claim 1, wherein selecting the maximum discount rate for the transaction negotiation package comprises:
summing a total monetary cost of the selection of menu items;
offsetting an upper discount bound from the preset target discount rate by a distance directly proportional to the total monetary cost of the selection of menu items;
offsetting a lower discount bound from the preset target discount rate by a distance inversely proportional to the total monetary cost of the selection of menu items; and
selecting the maximum discount rate from a spectrum of discount rates between the upper discount bound and the lower discount bound.

7. The method of claim 1, wherein selecting the maximum discount rate for the transaction negotiation package comprises:
retrieving a time-based discount curve defining a relationship between maximum discount rates and durations of time from a current time to proposed reservation dates and proposed reservation times;
selecting the maximum discount rate as an inverse function of a duration of time from the current time to the reservation date and the reservation time specified in the transaction negotiation package according to the time-based discount curve.

8. The method of claim 7, wherein selecting the maximum discount rate comprises selecting the maximum discount rate as an inverse function of the duration of time up to a time threshold before the reservation date and the reservation time specified in the transaction negotiation package and as a direct function of the duration of time from the time threshold to the reservation date and the reservation time specified in the transaction negotiation package.

9. The method of claim 7, wherein retrieving the time-based discount curve comprises:
summing a total monetary cost of the selection of menu items;
retrieving the time-based discount curve, from a set of time-based discount curves, associated with a range of total monetary costs comprising the total monetary cost of the selection of menu items.

10. The method of claim 1, further comprising:
detecting a location of the computing device;
accessing a virtual geospatial map indicating locations of a set of restaurants proximal the location of the computing device;
populating the virtual geospatial map with visual representations of a frequency of successful transaction negotiation packages specifying restaurants in the set of restaurants represented in the virtual geospatial map; and
serving the virtual geospatial map to the computing device for rendering within the customer portal.

11. method of claim 1, further comprising:
detecting a location of the computing device;
calculating a distance between the location of the computing device and a known location of the restaurant specified in the transaction negotiation package; and
in response to the reservation time and the reservation date specified in the transaction negotiation package falling within a threshold time from a current time, adjusting the maximum discount rate for the transaction negotiation package inversely proportional to the distance.

12. The method of claim 1, further comprising, in response to the initial monetary offer representing an initial discount rate exceeding the maximum discount rate by more than a threshold proportion of the maximum discount rate, rejecting the initial monetary offer and cancelling the transaction negotiation package.

13. The method of claim 1:
wherein serving the first monetary counter offer through the customer portal comprises serving the first monetary counter offer through the customer portal in response to the initial monetary offer representing an initial discount rate exceeding the maximum discount rate by less than a threshold proportion of the maximum discount rate; and
further comprising, in response to rejection of the first monetary counter offer by the user and receipt of a second monetary counter offer from the user:
processing payment for the selection of menu items according to the second monetary counter offer in response to the second monetary counter offer representing a second counter discount rate less than the maximum discount rate; and
in response to the second monetary counter offer representing a second counter discount rate exceeding the maximum discount rate:
serving a third monetary counter offer through the customer portal, the third monetary counter offer representing a third counter discount rate exceeding the maximum discount rate and less than the first monetary counter offer; and
in response to acceptance of the third monetary counter offer by the user through the customer portal, processing payment for the selection of menu items according to the third monetary counter offer.

14. The method of claim 13, further comprising:
further comprising retrieving a rate of success in a set of transaction negotiation packages previously submitted by the user; and
wherein serving the third monetary counter offer comprises selecting the third monetary counter offer representing the third counter discount rate between the second counter discount rate and the maximum discount rate and skewed toward the second counter discount rate directly proportional to the rate of success.

15. The method of claim 1, further comprising:
maintaining a count of monetary offers received from the user for the transaction negotiation package; and
in response to the count of monetary offers received from the user for the transaction negotiation package exceeding a threshold number prior to receipt of a monetary offer representing a discount rate less than the maximum discount rate, canceling the transaction negotiation package.

16. The method of claim 1, further comprising:
retrieving a rate of successful outcomes across a set of transaction negotiation packages previously submitted by the user; and
adjusting the threshold number—to trigger cancelation of the transaction negotiation package—directly proportional to the rate of successful outcomes.

17. The method of claim 1, wherein transmitting the reservation date, the reservation time, and the selection of menu items to the restaurant comprises:
serving the reservation date, reservation time, and the selection of menu items to a client portal affiliated with the restaurant in response to payment for the selection of menu items by the user; and
on the reservation date, inserting a first menu item in the selection of menu items into an electronic order placement system of the restaurant at a time preceding the reservation time by a preset preparation time for the first menu item, less a preset buffer time from the reservation time to target delivery of menu item to the user.

18. A method for automating negotiation of goods comprising:
initiating a transaction negotiation package based on a vendor, a purchase value, and an initial monetary offer for the purchase value selected by a user through a customer portal executing on a computing device;
retrieving, from a database, a target discount rate associated with the vendor and an aggregate discount rate of final discount rates negotiated for a set of transactions completed with the restaurant over a preceding period of time;
selecting a maximum discount rate for the transaction negotiation package based on a function of the preset target discount rate and the aggregate discount rate;
in response to the initial monetary offer representing an initial discount rate less than the maximum discount rate:
calculating a first counter discount rate as a linear combination of the maximum discount rate and the initial discount rate;
serving a first monetary counter offer through the customer portal, the first monetary counter offer representing the first counter discount rate; and
in response to the initial monetary offer representing the initial discount rate greater than the maximum discount rate:
serving a second monetary counter offer through the customer portal, the second monetary counter offer representing a second counter discount rate less than the maximum discount rate;
in response to acceptance of one of the first monetary counter offer and the second monetary counter offer by the user through the customer portal, processing payment for the selection of menu items according to the second monetary counter offer; and
transmitting confirmation of the transaction, the purchase value, and payment for the purchase value to the vendor.

19. The method of claim 18, wherein selecting the maximum discount rate for the transaction negotiation package comprises:
in response to the aggregate discount rate exceeding the preset target discount rate, setting a center discount rate below the preset target discount rate;
in response to the preset target discount rate exceeding the aggregate discount rate, setting the center discount rate for the transaction negotiation package above the preset target discount rate;
calculating an upper discount bound offset from the center discount rate by a static discount rate for the transaction negotiation package;
calculating a lower discount bound offset from the center discount rate by the static discount rate for the transaction negotiation package; and
pseudorandomly selecting the maximum discount rate between the upper discount bound and the lower discount bound.

20. The method of claim 18:
wherein serving the second monetary counter offer through the customer portal comprises, in response to the initial monetary offer representing the initial discount rate exceeding the maximum discount rate by less than a threshold proportion of the maximum discount rate:
calculating the second monetary counter offer representing the lesser of half of the initial discount rate and the maximum discount rate less a discount buffer; and
serving the second monetary counter offer through the customer portal;
further comprising, in response to rejection of the second monetary counter offer and receipt of a third monetary counter offer from the user:
processing payment for the purchase value according to the third monetary counter offer in response to the third monetary counter offer representing a third counter discount rate less than the maximum discount rate; and
in response to the third monetary counter offer representing a third counter discount rate exceeding the maximum discount rate:
serving a fourth monetary counter offer through the customer portal, the fourth monetary counter offer representing a fourth counter discount rate between the second discount rate and the third discount rate and exceeding the maximum discount rate; and
in response to acceptance of the fourth monetary counter offer by the user through the customer portal, processing payment for the purchase value according to the fourth monetary counter offer.

21. The method of claim 18:
wherein initiating the transaction negotiation package comprises initiating the transaction negotiation package based on a vendor and a second vendor indicated by the user through the customer portal;
wherein calculating the first counter discount rate and serving the first monetary counter offer through the customer portal comprise negotiating a first final discount rate of the transaction negotiation package with the user on behalf of the vendor; and
further comprising simultaneously negotiating the first final discount rate of the transaction negotiation package and negotiating a second final discount rate of the transaction negotiation package with the user on behalf of the second vendor through the customer portal.
